(19) United States
(12) Patent Application Publication
(10) Pub. No.: US 2007/0070427 A1
(43) Pub. Date: Mar. 29, 2007

(54) Systems and methods for selective dithering using pixel classification

(75) Inventors: Brian E. Cooper, Lexington, KY (US); Shaun T. Love, Lexington, KY (US); Steven F. Weed, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc., Lexington, KY (US)

(21) Appl. No.: 11/465,599

(22) Filed: Aug. 18, 2006

Related U.S. Application Data
(60) Provisional application No. 60/709,914, filed on Aug. 18, 2005.

(51) Int. Cl. H04N 1/405

(52) U.S. Cl. 358/3.14

(57) ABSTRACT

A method of selective dithering for enhancing the printability of an image, including receiving input pixels of an original input image and identifying the pixel classification of the input pixels, where the pixel classification characterizes each of the plurality of pixels based, at least in part, on their respective gray values. Thereafter, a dither input is added to at least some of the input pixels to generate a filtered and dithered image, where the strength of the dither input applied to generate the filtered and dithered image is based on the pixel classification. Full dither may be applied for smooth pixels, and little or no dither may be applied for edge pixels.

### CROSS REFERENCES TO RELATED APPLICATIONS

This application claims priority to U.S. provisional patent application No. 60/709,914 titled, “Systems and Methods for Selective Dithering Using Pixel Classification,” which was filed on Aug. 18, 2005.

### FIELD OF THE INVENTION

The present invention relates generally to systems and methods for enhancing printability of documents, and more particularly, to systems and methods that enhance printability of document images based upon the content of such documents.

### BACKGROUND OF THE INVENTION

Error diffusion is one of the most pervasive techniques for generating halftones (as for printing) from contone raster images. Error diffusion avoids aliasing artifacts to which thresholding is vulnerable, but primitive error diffusion implementations are not well-suited to print technologies such as electrophotographic or “laser” printing with the strong interdependencies among adjacent dots.

One set of error diffusion techniques for clustering dots involves hysteresis in the diffusion. Spatial hysteresis requires more extensive error buffering, which represents an appreciable cost for high-resolution implementations. Alternatively, clustering may be forced by adding spatially-dependent dither to error diffusion's threshold. However, visible artifacts result from interference between the frequencies of spatially dithered thresholds and error diffusion's natural, tone-dependent frequencies. This interference can be avoided by applying a lower amplitude clustering dither to input in lieu of (or in coordination with a lesser amount of) threshold dither. This approach for clustering dots is described further in the U.S. Non-Provisional Patent Application titled “Apparatus and Method for Error Diffusion with Dither”, filed on Aug. 18, 2005, and assigned to the assignee of the present invention, the contents of which are incorporated herein as if set forth fully herein.

Nevertheless, techniques to interfere with error diffusion artifacts or cluster output also disrupt the reproduction of spatial details from contone raster images. Therefore, what is needed is error diffusion that applies the results of pixel classification to adjust the behavior of the error diffusion.

### BRIEF SUMMARY OF THE INVENTION

According to the present invention, pixel classification guides the manner in which error diffusion is performed. For inputs with slowly changing values (i.e., low spatial frequencies), clustered error diffusion may be used to improve uniformity. In such a scenario degradation of detail is not relevant because detail is also absent in the input. In contrast, for input with rapidly changing values, (i.e., high spatial frequencies), the present invention does not apply spatial dither. In those situations uniformity is not relevant since the input itself is highly varying.

According to an embodiment of the present invention, pixel classification determines whether spatially-dependent clustering dither is utilized. Pixels classified as low-frequency (i.e., pixels in a smooth area) use clustering dither while high-frequency pixels (e.g., edges) do not. According to an aspect of the present invention, a range of strengths of the clustering dither may also be selected based upon the relative frequency in a pixel's neighborhood. The strength of the clustering dither may be greatest with the lowest-frequency input and least with the highest-frequency input, with intermediate strengths possible for input with intermediate frequency levels. According to another embodiment, pixel classification determines the filtering that is applied to the dither. Pixels classified as low-frequency select an identity filter and thus, clustering dither is applied, providing stability. Pixels classified as high-frequency select a smoothing filter. The smoothing filter can attenuate the pattern of the dither. At the extreme, such smoothing would blur the dither into a flat, constant signal, and the resulting attenuated or smoothed dither produces less clustering.

According to yet another embodiment of the present invention, there is disclosed a method of selective dithering. The method includes receiving a plurality of input pixels of an original input image and identifying the pixel classification of the plurality of input pixels, where the pixel classification characterizes each of the plurality of pixels based, at least in part, on their respective gray values. The method also includes adding a dither input and at least some of the plurality of input pixels to generate a dithered image, where the strength of the dither input applied to generate the dithered image is based on the pixel classification of at least some of the plurality of input pixels.

According to one aspect of the present invention, adding a dither input and at least some of the plurality of input pixels includes adding a dither input and at least some of the plurality of input pixels using at least one interpolation table. Adding a dither input and at least some of the plurality of input pixels may alternatively include adding a dither input and at least some of the plurality of input pixels using at least one adder. According to another aspect of the present invention, the method further includes attenuating the dither input based on the pixel classification prior to adding the dither input and the at least some of the plurality of input pixels. According to yet another aspect of the present invention, the attenuation comprises a convolution filter whose coefficients are determined by the pixel classification of the plurality of input pixels.

According to another aspect of the present invention, the method includes performing error diffusion on the dithered image. Additionally, the pixel classification may be operable to characterize at least one of the plurality of pixels as an edge pixel or as a smooth pixel. Furthermore, the strength of the dither input applied to generating the dithered image may be lower for the edge pixel than for the smooth pixel.

According to another embodiment of the present invention, there is disclosed a method of applying dithering. The method includes determining the pixel classification of a plurality of input pixels in an original image and selecting, based upon the pixel classification, whether or not to add a dither input to at least some of the plurality of input pixels of the original image, where the dither input is not added to the at least some of the plurality of input pixels if the determined pixel classification is a first pixel classification, and the dither input is added to the at least some of the plurality of the input pixels if the determined pixel classification is a second pixel classification.

According to an aspect of the invention, the method may also include selectively attenuating the dither input based on the determined pixel classification. Additionally, selectively attenuating the dither input may be implemented by at least one filter. According to another aspect of the present invention, the method may also be performed by an application specific integrated circuit.

According to yet another embodiment of the invention, there is disclosed a system for applying dither. The system includes a dither input, a plurality of input pixels corresponding to an original input image, and a pixel classification module, where the pixel classification module is operable to receive the plurality of input pixels and further operable to characterize each of the plurality of pixels based, at least in part, on the respective gray values of neighboring pixels. The system may also include an adder, in communication with the dither input, where the adder is operable to add the dither input to at least some of the plurality of input pixels to generate a dithered image, where the strength of the dither input in generating the dithered image is based on the pixel classification of at least some of the plurality of input pixels.

According to one aspect of the invention, the adder includes one or more interpolation tables, which may be selected based on the pixel classification of at least some of the plurality of input pixels. According to another aspect of the present invention, the system may also include at least one smoothing filter operable to receive and attenuate the dither input based on the pixel classification of at least some of the plurality of input pixels prior to the adding of the dither input and the at least some of the plurality of input pixels. The system may also include at least one image filter operable to receive and filter the input pixels prior to the adding of the dither input and the at least some of the plurality of input pixels.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a system for selectively dithering an input image using pixel classification, according to an illustrative embodiment of the present invention.

FIG. 2 shows a system for selectively dithering an input image using pixel classification, according to another illustrative embodiment of the present invention.

FIG. 3 shows a flowchart of a process of a method implemented by the system of FIG. I, according to an embodiment of the present invention.

FIG. 4 shows a flowchart of a process of a method implemented by the system of FIG. 2, according to an embodiment of the present invention.

FIG. 5 shows a block diagram of an application specific integrated circuit (ASIC) configured to perform error diffusion using selective dither, according to an embodiment of the present invention.

### DETAILED DESCRIPTION OF THE INVENTION

The present invention will now be described more fully hereinafter with reference to the accompanying figures, in which like numerals indicate like elements throughout the several drawings. Some, but not all embodiments of the present invention are described. Indeed, the present invention may be embodied in many different forms and should not be construed as limited to the embodiments set forth herein; rather, these embodiments are provided so that this disclosure will satisfy applicable legal requirements. Also, it is to be understood that the phraseology and terminology used herein is for the purpose of description and should not be regarded as limiting. The use herein of “including,” “comprising” or “having” and variations thereof is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. The order of limitations specified in any method claims does not imply that the acts set forth therein must be performed in that order unless an order is explicitly set forth in the specification.

In addition, it should be understood that embodiments of the present invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present invention may be implemented in software. As such, it should be noted that a plurality of hardware and software based devices, as well as a plurality of different structural components may be utilized to implement the present invention. Furthermore, and as described in subsequent paragraphs, the specific mechanical configurations illustrated in the drawings are intended to exemplify embodiments of the present invention, and other alternative mechanical configurations are possible.

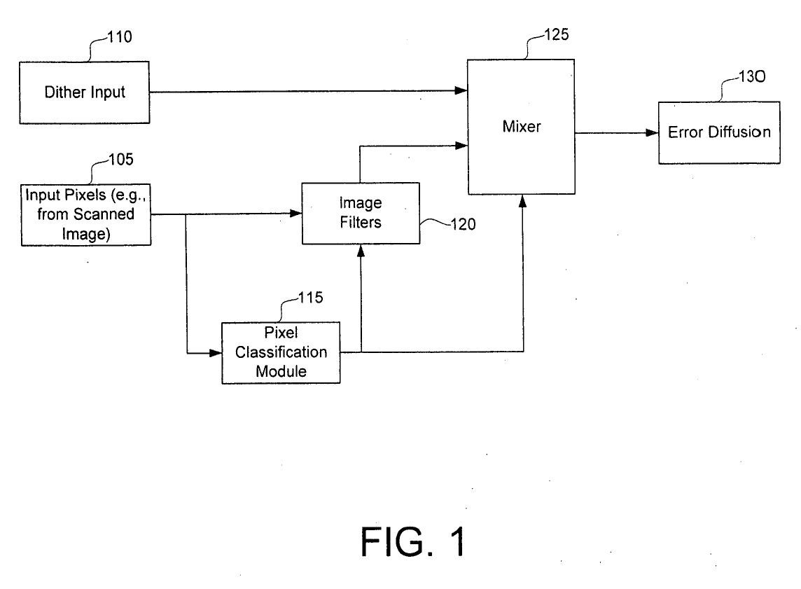

Referring now to FIG. 1, there is illustrated a system 100 for selectively dithering an input image, according to an illustrative embodiment of the present invention. The system 100 is operable to apply dither to input pixels based on pixel classification, as described in detail below. In particular, dither is applied to input pixels whose gray values may prove difficult to print if they were otherwise provided as error diffusion input. As a result, the system 100 is operable to enhance the output of the error diffusion to improve the printed version of an input image.

According to the illustrative embodiment of the present invention shown in FIG. 1, the output of the system 100 may be used as the input for error diffusion. It will be appreciated, however, that the application of dither to input pixels based on pixel classification may also be employed to apply dither within an error diffusion process. Therefore, although the systems and methods of the present invention are described herein as providing a filtered and dithered image used as error diffusion input, the systems and methods of the present invention may also be employed within an error diffusion process that receives an original image as input. Therefore, it will be appreciated that the embodiments illustrated and described with respect to FIGS. 14 are intended to be illustrative and non-limiting examples of the present invention.

As shown in FIG. 1, the system 100 receives, as input, input pixels 105, which may represent an image transmitted to the system 100 from a scanner or the like over a communications path. According to one aspect of the present invention, the system 100 may be implemented in an Application Specific Integrated Circuit (ASIC) located within a printer or multi-function device (i.e., a device capable of performing multiple functions, such as printing, scanning and/or copying). Therefore, the input pixels 105 may be communicated from a scanning device or scan module (not illustrated) to an ASIC for processing as described herein. It will be appreciated that the input pixels 105 may also be received from a remote location via a network communication channel, such as from a remote computer in communication with the system 100.

As shown in FIG. 1, the received input pixels 105 are transmitted to the pixel classification module 115 and two or more image filters 120. Generally, the pixel classification module is used to identify those input pixels 105 to which dither should be applied and to control the addition of dither to the input pixels 105. Specifically, the pixel classification module 115 is operable to classify each input pixel as belonging to one of a plurality of pixel classifications. The pixel classification module 115 outputs pixel classifications as an output classification signal. According to one aspect of the present invention, pixels may be classified as smooth, edge, or mixed. However, it will be appreciated that other pixel classifications can also be utilized. For instance, text, picture and background pixel classifications may be used. According to another aspect of the present invention, pixel classifications may also identify whether pixels are in light or dark regions of an image, which may be used to modulate the nominal spectral power distributions of dither.

According to an aspect of the present invention, the classification of the input pixels 105 may be accomplished by systems and methods disclosed in U.S. patent application Ser. No. 10/744,884, filed on Dec. 23, 2003, and titled “JPEG Encoding For Document Images Using Pixel Classification”, which is assigned to Lexmark International, Inc., the contents of which are incorporated by reference as if set forth fully herein. According to another aspect of the invention, the classification of pixels may be accomplished by systems and methods disclosed in U.S. patent application Ser. No. 10/224,660, filed on Aug. 20, 2002, titled “Systems and Methods For Content-Based Document Image Enhancement”, which is assigned to Lexmark International, Inc., the contents of which are incorporated by reference as if set forth fully herein. Collectively, the Ser. Nos. 10/744,884 and 10/224,660 patent applications will be referred to hereafter as the “Pixel Classification Applications.”

The pixel classification module 115 may incorporate any combination of hardware and/or software used to implement pixel classification as described in the Pixel Classification Applications. In particular, the pixel classification module 115 may classify each input pixel based on an analysis of neighboring pixels. According to one aspect, a feature vector can be developed to establish pixel classification, where the feature vector condenses the description of relevant properties of each pixel in the image into a small, Euclidean feature space. The number and type of elements included in the feature vector can be selected based on the complexity of the image. For instance, the elements of the feature vector may include, e.g., gray values, gray values obtained through different filters, texture measures, Markov random field features, fractal dimension measures, and gradient magnitudes and directions. In other words, the elements for a given pixel typically provide a measure of change occurring in the image at that pixel based on image data analyzed from neighboring pixels. The feature vector, and other values based thereon, may be used to classify each of the input pixels 105 using neighboring pixels, as described in detail in the Pixel Classification Applications. According to another aspect of the present invention, pixel classification may be based on each of, or one or more of, the color components for color pixels. Other pixel components in addition to gray scale and color components may also be used to classify pixels. For instance, derivatives of color components, such as luminance, may also be used for pixel classification.

Alternatively, as will be recognized, region based image segmentation can provide pixel classification information. Pixel classification may also be available a priori, such as generated from region based segmentation, or from information provided or based upon a display list representation of the image contents.

Referring once again to FIG. 1, according to one embodiment, the pixel classification module 115 is also used to determine how the input pixels 105 are filtered by the two or more image filters 120. More specifically, the two or more image filters 120 may be operable to filter pixels corresponding to each of the pixel classifications. For instance, where the pixel classification module 120 identifies smooth, edge and mixed pixels, the image filters 120 may include separate filters operable to filter smooth, edge and mixed pixels from the input pixels 105, as is known to those of ordinary skill in the art. Therefore, the output of the pixel classification module can determine the activated filter of the two or more image filters 120 for filtering the input pixels 105. It will be appreciated that leveraging the use of pixel classification for the filtering of input pixels 105 is optional. Additionally, pixel classifications for filtering, e.g., by the two or more filters 120, or other image processing may be separate from those pixel classifications used herein for conditional dot-clustered error diffusion, as described below.

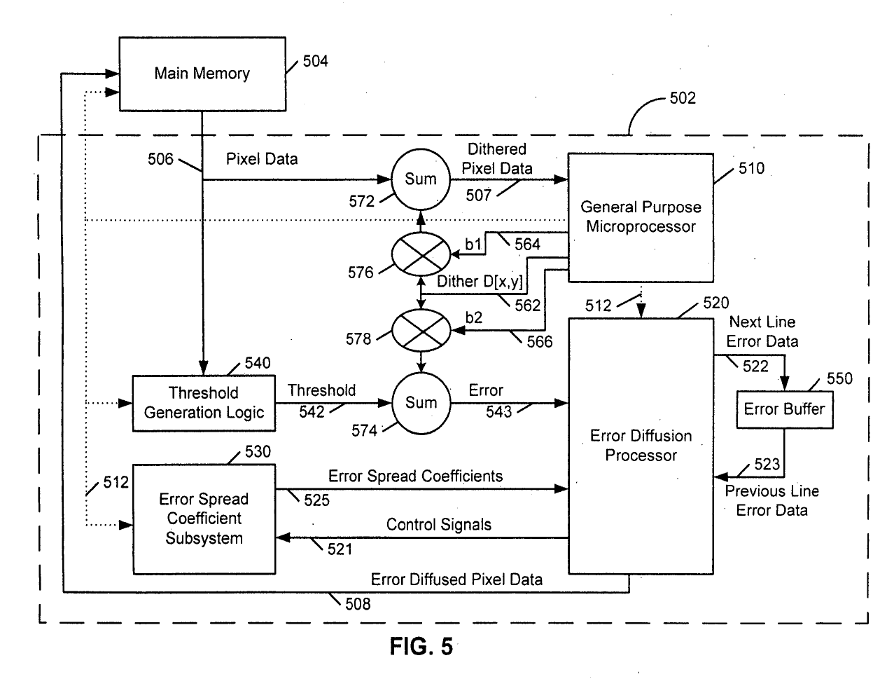

As is also shown in FIG. 1, once a pixel is classified by the pixel classification module 115, the output pixel classification signal is used to control the application of a dither input 110 using a mixer 125, such as interpolation tables. A dither input 110, as is known in the art, is used to alter the value of the input pixels 105, for instance, to make gray values darker or lighter in a neighborhood of pixels such that an image may be recreated by a printer, multifunction device or other printing device. The mixer 125, which may alternatively comprise an adder, as is known in the art, receives as input the pixel classification signal and the dither input 110 and outputs a filtered and dithered image. According to one aspect of the invention, the filtered and dithered image may be used as input to error diffusion 130. However, as described above, the generation of a filtered and dithered image using the process described herein may also occur as part of an error diffusion process that receives, for instance, the input pixels 105 as input. In such an embodiment, the pixel classification is being used within the error diffusion process. Pixel classification may (or may not) be used to directly or indirectly modulate error diffusion parameters such as threshold components or diffusion weights, which are described in greater detail below with respect to FIG. 5.

The mixer 125 represents multiple different interpolation tables that may be used to mix the input dither 110 with the filtered image received from the image filters 120. According to an aspect of the present invention, the mixer 125 represents two dimensional interpolation tables existing within an ASIC that implements the system 100. The contents of the two dimensional interpolation tables represent the sum of the dither input 110 and filtered image pixel inputs.

Depending on the pixel classification, and in particular, the pixel classification signal output of the pixel classification module 115, different interpolation tables may be used to effect dither of different strengths. As described above and as shown in FIG. 1, there are three inputs to the mixer 125, where the first is the filtered image input and the second is the input dither, which is tiled to match the width of the filtered image input. The third input is the pixel classification signal output, which is used to select the two dimensional interpolation table used to effect the mixing of the dither and pixel input. In particular, there are separate two dimensional tables for each of the different pixel classifications, where each table alters the strength of the dither applied to input pixels. For instance, where pixels are classified as smooth, edge, and mixed pixels, the pixel classification signal is used to identify the corresponding interpolation table used to effect mixing. Pixels classified as smooth may receive dither of a higher strength than those classified as edge, which may receive no or very little dither. Thus, each of the one or more interpolation tables includes values that represent different sums of the dither input 110 and filtered image pixel inputs, depending on the strength given to the dither input 110.

Although illustrated as interpolation tables, it will be appreciated by those of ordinary skill in the art that the mixer 125 may alternatively comprise adders to combine the dither input 110 with the filtered image output of the image filters 120. Multiple adders are necessary to alter the strength of mixing among the dither and input pixels. Nevertheless, because interpolation tables can allow amplitudes resulting from dither and pixel values to be constrained to the dynamic range of pixels while maintaining effectively zero mean dither, an equivalent arithmetic logic to the interpolation tables may be more complicated than a simple arithmetic adder, as will be appreciated by those of ordinary skill in the art.

As shown in FIG, 1, according to one embodiment, the output of the mixer 125 may be used as the input to error diffusion 130. The system 100 of FIG. 1 applies selective dot-clustering dither to the input of error diffusion based on pixel classification. Because error diffusion is effective at reproducing some portions of an input image, such as edges, dither is not applied (or applied in very low strength) to those pixels. However, using the system 100, dither is applied to pixels that may prove difficult for error diffusion to effectively handle, such as smooth pixels. As a result, the system 100 is effective at enhancing the output of error diffusion.

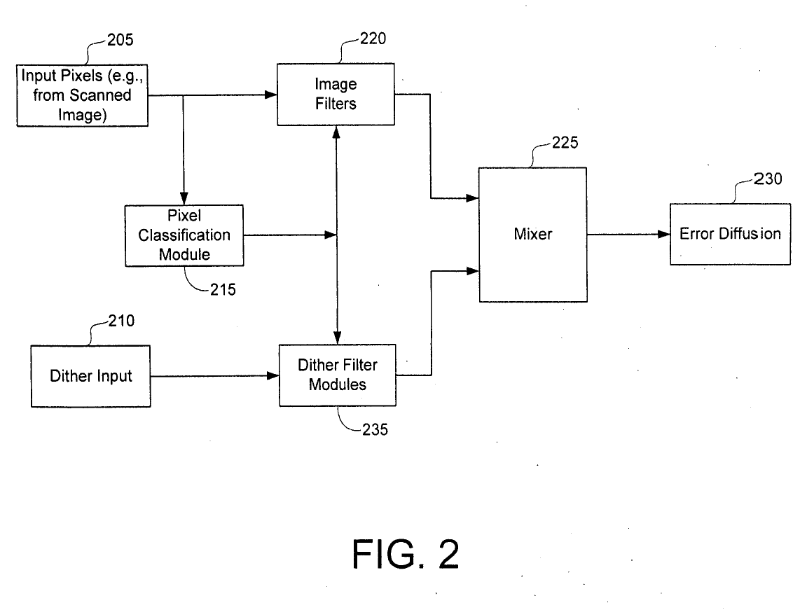

FIG. 2 shows a system 200 for selectively dithering an input image using pixel classification, according to another illustrative embodiment of the present invention. Like the system 100 described above with respect to FIG. 1, the system 200 shown in FIG. 2 includes input pixels 205 that are fed into a pixel classification module 215 and two or more image filters 220. These elements 205, 215, 220 are therefore similar to the corresponding elements 105, 115, 120 described with respect to FIG. 1. Therefore, the pixel classification module 220 is used in the system 200 of FIG. 2 to determine how the input pixels 205 will be filtered by the image filtering modules 220. According to an embodiment of the present invention, each of the input pixels 205 may be identified by three different classifications, including smooth, edge or mixed, and the image filters 220 may include separate filters corresponding to each different classification.

In the system 200 of FIG. 2, the dither input 210 is fixed and is varied in strength using dither filter modules 235, which attenuate the dither input 210. The attenuation provided by dither filter modules 235 is changed based on the pixel classification signal output from the pixel classification module 215. Therefore, in addition to controlling the type of filter applied to the input pixels 205, the pixel classification module 215 is used to control the application of dithering to the input pixels 205.

According to one aspect of the present invention, where the pixel classification module 215 determines pixel classification based, for example, on a 5 x 5 block of pixels with the center pixel of the block receiving classification, the dither filter modules 235 may be, for example, a 5 x 5 convolution filter with equal coefficients, where the center coefficient is applied to the pixel being filtered and the surrounding coefficients are correspondingly applied to surrounding pixels. Coefficients can be normalized so that they sum to unity; for example, each coefficient for the maximally smoothing 5×5 convolution filter is 1/25.

As described above, a feature vector can be developed to establish pixel classification. It will be appreciated that as the feature vector for pixel classification changes, differences in the feature vector resulting from edges or text input pixels can result in changes in the dither filter modules 235. For instance, where the dither filter modules 235 is a convolution filter, differences in the feature vector may cause incremental changes in 5×5 convolution filter coefficients, where the center coefficient will increase to 1 for a smooth image and the surrounding coefficient will decrease to 0, in which case the dither filter modules 235 applies no attenuation to the dither input 210.

It will be appreciated that whereas in FIG. 1 the pixel classification module 115 is used to control the strength of the dither by transmitting the pixel classification signal to the interpolation tables 125, in the system 200 of FIG. 2 the strength of the dither is based on the output of the dither filter modules 235. Thus, the pixel classification module 215 is still used to control the application of the dither, but through the output of the dither filter modules 235, and not through control of the mixer 225, such as interpolation tables or adders. As shown in FIG. 2, the interpolation tables receive, as input, the filtered image and the smoothed dithered input and outputs a filtered and dithered image, which according to one aspect of the present invention may be used as the input to error diffusion 230. Because the strength of the dither is controlled by the dither filter modules 235, a single two-dimensional interpolation table may be used to effect the adding of the attenuated dither and the filtered input pixels.

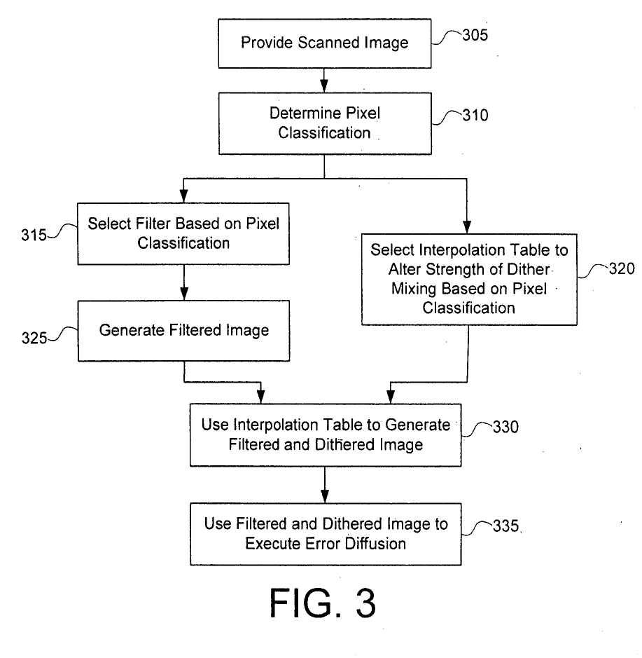

FIG. 3 shows a flowchart of a process 300 of a method implemented by the system of FIG. 1, according to an embodiment of the present invention. As shown in FIG. 3, input pixels provided from a scanned image (block 305) are received, after which their pixel classification is determined (block 310). Based on the pixel classification, a filter corresponding to the pixel classification is selected (block 315), and the input image is filtered using the selected filter (block 325). Based on the pixel classification, an interpolation table is selected to alter the strength of dither mixing (block 320). Thereafter, the selected interpolation table (or an adder) is used to generate a filtered and dithered image (block 330), which is then used as the input to effect error diffusion (block 335).

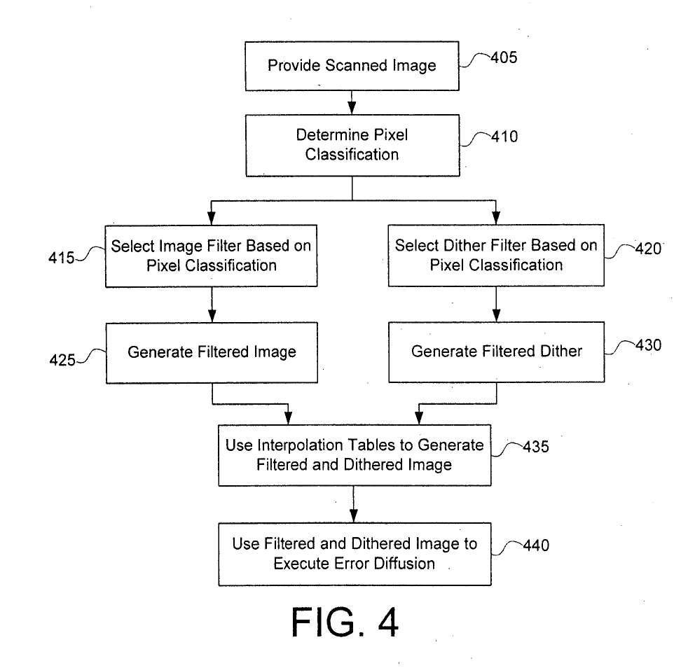

FIG. 4 shows a flowchart of a process 400 of a method implemented by the system of FIG. 2, according to an embodiment of the present invention. As shown in FIG. 4, input pixels provided from a scanned image (block 405) are received, after which their pixel classification is determined (block 410). Based on the pixel classification, a filter corresponding to the pixel classification is selected (block 415), and the input image is filtered using the selected filter (block 425). Based on the pixel classification, a dither filter (e.g., a smoothing filter) is also selected (block 420) and the dither is filtered using the selected dither filter (block 430). Thereafter, a mixer, such as interpolation tables or adders, is used to generate a filtered and dithered image (block 435), which is then used as the input to effect error diffusion (block 440).

FIG. 5 shows a block diagram of a system 500 configured to perform error diffusion using the selective dither process described above, according to an embodiment of the present invention. According to an aspect of the present invention, the system 500 may belong to a printer that receives an image with multi-bit data pixels and outputs halftone images while using an error diffusion algorithm, not unlike the Floyd-Steinberg algorithm, as is known in the art. Generally, the system 500 includes a general purpose microprocessor 510 that is connected to a main memory 504. The main memory 504 typically stores the input pixel data 506 of an image whose pixels are to be transformed from a non-binary format to a binary format using error diffusion.

In the illustrative embodiment of FIG. 5, the microprocessor 510 is part of an ASIC 502 (represented by the dashed line) configured to implement error diffusion. The dotted arrows represent connections between the microprocessor 510 and the other components of the ASIC 502, through data buses, control buses and other structures known to those skilled in the art of integrated circuit design. A second microprocessor (not shown) off the ASIC 502 may also be used for overall control for enabling/disabling the ASIC 502 or components thereof, setting various coefficients and parameters such as image dimensions and pixel line addresses, and the like. In addition to the microprocessor 510, the ASIC 502 includes an error diffusion processor 520, an error spread coefficient subsystem 530, threshold generation logic 540, and an error buffer 550.

The general purpose processor 510 receives pixel data 506 from the main memory 504. The error diffusion processor 520 receives error spread coefficients 525 from the error spread coefficient system 530 and modified threshold information or error 543. The error diffusion processor 520 uses this information, along with previous line running error data 523 from an error buffer 550 to transform the pixel data 506 into error diffused pixel data 508 which is stored in the main memory 504. Control signals 521 are sent from the error diffusion processor 520 to the error spread coefficient system 530 for requesting coefficients and performing other functions. Alternative error spread coefficients may be provided based on pixel classification.

The error spread coefficient system 530 receives input 512 from the microprocessor 510. It may also receive pixel data 506 in the case of data-driven determinations of the error spread coefficients 525. The error spread coefficient system 530 provides the error diffusion processor 520 with the error spread coefficients 525 to be used in allocating the error from a transformed pixel. As discussed further below, the error spread coefficient system 530 may be implemented in a number of different ways.

The threshold generation logic 540 is under the control of the microprocessor 510 and may take on any number of forms. As seen in FIG. 5, the threshold generation logic 540 receives the pixel data 506, and so the thresholds are tone-dependent. In such case, threshold generation logic 540 may comprise a look up table, with input pixel values being mapped onto threshold values. Additional circuitry may be provided to manipulate the tone dependent threshold values using enhanced precision within the ASIC 502.

The ASIC 502 of FIG. 5 includes the addition of passband dither to the input image pixels through the use of multipliers and first and second coefficients, b1 and b2. Specifically, the microprocessor 510 may output data 562, 564, 566 corresponding to an appropriate dither value D[x,y] 562, a first coefficient b1 564 and a second coefficient b2 566. While the data lines 562, 564, 566 are seen as discrete lines for illustration purposes, it is understood that the corresponding information may be provided on a data bus with appropriate signaling.

Specifically, the first coefficient b1 564 and the dither value D[x,y] 562 are input to a first multiplier 576, and the first product from this first multiplier 576 is forwarded to first adder 572. At first adder 572, this first product is added to the input pixel value Iₒ[x,y] 506 to form the dithered pixel data Iₙ[x,y] 507. Preferably, first coefficient b1 is less than 1.0 so that the output of multiplier 576 (i.e., the passband dither) has a smaller dynamic range than original input pixel values Iₒ[x,y] 506. The second coefficient b2 566 and the dither value D[x,y] 562 are input to a second multiplier 578, and this second product is forwarded to second adder 574. At second adder 574, this second product is added to the tone-dependent threshold value Tₙ[Iₒ[x,y]] 542 to produce modified threshold value Tₘ[x,y] (i.e., error) 543, which is then input to the error diffusion processor 520.

It is noted that while ASIC 502 shows that the original input pixel data Iₒ[x,y] 506 is used to index the threshold values in the threshold generation logic 540, one may instead connect the dithered pixel data Iₙ[x,y] 507 to the threshold generation logic 540 to thereby use information from the dithered input pixel values to index the threshold values. It is also noted that in the ASIC implementation of FIG. 5, passband dither of the same type (D[x,y]) 562 is added to both the input pixel values and to the thresholds.

Furthermore, the microprocessor, or other hardware, can be configured to produce or otherwise provide the various passband dither signals discussed above; look for edges in a region proximate to a pixel of interest and, if appropriate, suspending addition of the first type of passband dither; and determine an average pixel value in a region proximate to a pixel of interest and, if appropriate, take any necessary action, all as discussed above. In the implementation of ASIC 502, the dithered input pixel values Iₙ[x,y] 507 are computed with hardware adders and multipliers. For example, the microprocessor 510 may perform the entire computation in software and provide dithered input pixel values Iₙ[x,y] 507 to the error diffusion processor 520. Alternatively, in one embodiment, the dither values D[x,y] 562, already scaled by b1, may be stored in a lookup table, indexed by the pixel [x,y] position, and accessible to the microprocessor 510 which then adds the retrieved information to the input pixel value 506 and again provides the result to the error diffusion circuitry. Such a lookup table may form a portion of the microprocessor's local memory. The same principles hold for producing the modified threshold values Tₘ[x,y] 543. The ASIC 502 may be configured in some manner to add the proper first type of dither to the input pixel values, and add the proper second type of dither to the threshold values. In the embodiment shown, the first type of passband dither and the second type of passband dither have the same spectral characteristics and differ by a scalar multiple.

Finally, as is known to those skilled in the art, the error diffusion processor 520 typically processes image pixel data in line-order—each pixel belonging to one line of an image is error diffused, before pixels of the next line are processed. The error buffer 550 receives next line error data 522 from the error diffusion processor 520 for use in distributing the error from an immediately preceding row of image data and provides these errors back 523 to the error diffusion processor 520 for use in adjusting a current pixel value of a pixel in a current row of image data. It is understood that in some prior art embodiments, the error buffer 550 may be instantiated in main memory 504 when memory bandwidth suffices to support the pixel rate. In other prior art embodiments, circuitry for implementing the error buffer 550 may simply be integral to the error diffusion processor 520.

While in the prior art embodiment of FIG. 5 error diffusion is performed using dedicated hardware in the ASIC 502, it may instead be performed entirely in software by the microprocessor 510. Indeed, as is known to those skilled in the art of designing ASICs, it is even possible to do away with the microprocessor 510 entirely and implement all the needed functionality using micro-processor-free circuitry. It is further understood that in some prior art embodiments, the main memory 504 may also be part of the ASIC 502, or the input pixel data 506 may be stored in a local memory on-board the ASIC.

Many modifications and other embodiments of the present invention set forth herein will come to mind to one skilled in the art to which this invention pertains having the benefit of the teachings presented in the foregoing descriptions and the associated drawings. Therefore, it is to be understood that the present invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of conditionally dithering, comprising:
receiving a plurality of input pixels of an image;
generating a dithered image by conditionally applying dither values to:
the plurality of input pixels, or
a plurality of modified input pixels representing the plurality of input pixels modified at least in part using pixel classification values,
wherein the pixel classification values are based on at least one characteristic associated with each of the plurality of input pixels.

2. The method of claim 1, wherein the pixel classification values are operable to characterize at least one input pixel of the plurality of input pixels as belonging to an edge of the image.

3. The method of claim 1, wherein the pixel classification values are operable to characterize at least one input pixel of the plurality of input pixels as belonging to a smooth region in the image.

4. The method of claim 1, wherein the dither values may be varied at least in part according to the pixel classification values.

5. The method of claim 4, wherein the dither values are varied by filtering arrays of the dither values.

6. The method of claim 5, further comprising determining the coefficients of a filter based at least in part on the pixel classification values.

7. The method of claim 1, wherein the dither values are varied by scaling.

8. The method of claim 1, wherein the dither values are zero-mean.

9. The method of claim 1, wherein the dither values are varied at least in part according to corresponding pixel component values of the plurality of input pixels.

10. The method of claim 1, wherein the pixel classification values are based at least in part on input pixel component values of the plurality of input pixels.

11. The method of claim 10, wherein the input pixel component values represent color information about the image.

12. The method of claim 11, wherein the color information is separated into a luminance component and at least one chroma components.

13. The method of claim 10, wherein the dither is applied in varying strengths corresponding to at least one input pixel component value of the plurality of input pixels.

14. The method of claim 1, wherein the pixel classification values for the plurality of input pixels are predetermined.

15. The method of claim 1, further comprising applying error diffusion to the dithered image.

16. The method of claim 15, wherein the error diffusion is based at least in part on the pixel classification values.

17. The method of claim 1, wherein the pixel classification values are based at least in part on a measured spatial spectral power in the vicinity of each pixel of the plurality of input pixels.

18. The method of claim 1, wherein the dither values are applied to the plurality of input pixels using at least one adder.

19. The method of claim 1, wherein the dither values are applied to the plurality of input pixels using at least one interpolation table.

20. The method of claim 1, wherein strength of the dither applied to generate the dithered image is lower for pixel classification values associated with edges of the image than for smooth regions in the image.

21. A system for conditionally applying dither, comprising:
a dither input;
a plurality of input pixels corresponding to an original input image;
a pixel classification module, wherein the pixel classification module is operable to receive the plurality of input pixels, and further operable to associate each of the plurality input of pixels with at least one characteristic; and
a mixer, in communication with the dither input, wherein the mixer is operable to apply dither values to the plurality of input pixels.

22. The system of claim 21, wherein the pixel classification module comprises, at least in part, an application specific integrated circuit.
